(19) United States
(12) Patent Application Publication
(10) Pub. No.: US 2009/0205445 A1
(43) Pub. Date: Aug. 20, 2009

(54) METHOD FOR SELECTING A FILTER ELEMENT FOR A DUST COLLECTOR

(76) Inventor: Thomas D. Raether, St. Louis Park, MN (US)

Correspondence Address: MERCHANT & GOULD PC, P.O. BOX 2903, MINNEAPOLIS, MN, 55402-0903, US

(21) Appl. No.: 12/329,757

(22) Filed: Dec. 8, 2008

Related U.S. Application Data
(60) Provisional application No. 61/028,772, filed on Feb. 14, 2008.

(51) Int. Cl. G01N 1/22

(52) U.S. Cl. 73/863.23

(57) ABSTRACT

A method of providing a filter element for a dust collector having at least one circular blowpipe and pulse arrangement includes measuring an inside diameter of the blowpipe; and selecting a filter element having a width that is 7.125±0.75 inches times the inside diameter of the blowpipe; and a length that is 2.2-3.3 times the width.

This application claims priority to U.S. provisional patent application Ser. No. 61/028,772 filed Feb. 14, 2008.

### TECHNICAL FIELD

This disclosure relates to dust collectors utilizing reverse-pulse cleaning. In particular, this disclosure relates to a method for selecting a size of filter element based on the size of the pulse.

### BACKGROUND

Dust collectors are used in factories, industrial settings, and other environments in which more than a desirable amount of particulate material is floating in the air. For example, such particulate material can include dust or dirt.

Typical dust collectors can be embodied in the form of housings that hold several filter elements, the filter elements being in the form of cloth bags, tubular elements, or panel filters. In typical use, after a period of operation, the filter elements are cleaned while still operably installed in the dust collector. For example, filter elements are often pulsed with compressed air through a nozzle having a blow pipe. The compressed air flows from the downstream (clean side) to the upstream (dirty side). The pulse of compressed air helps to dislodge dust caked on the upstream side of the element.

There are many methods for pulse cleaning filters in dust collectors. Venturi, nozzles, tubes, center bodies, pulse splitters, etc., have all been utilized in an attempt to improve pulse cleaning of the filter. Most of these mechanical features have been introduced because of a poor match between the size of the filter and the size of the pulse. Improvements are desirable.

### SUMMARY OF THE DISCLOSURE

A method of providing a filter element for a dust collector having at least one circular blowpipe and pulse arrangement includes measuring an inside diameter of the blowpipe; and selecting a filter element having a width that is 7.125±0.75 inches times the inside diameter of the blowpipe; and a length that is 2.2-3.3 times the width.

It is noted that not all the specific features described herein need to be incorporated in a method or arrangement for the method or arrangement to have some selected advantage according to the present disclosure.

### BRIEF DESCRIPTION OF THE DRAWINGS

FIG. 1 is a schematic view of a dust collector constructed in accordance with principles of this disclosure;

FIG. 2 is a schematic diagram explaining principles of pulsing, according to principles of this disclosure;

FIG. 3 is a schematic diagram showing principles of pulsing, utilizing principles of this disclosure;

FIG. 4 is a schematic diagram, illustrating principles of this disclosure;

FIG. 5 is a schematic diagram, illustrating principles of this disclosure;

FIG. 6 is a schematic diagram showing pulsing of a tubular filter element or bag, utilizing principles of this disclosure;

FIG. 7 is a schematic diagram showing pulsing of a tubular filter element, using principles of this disclosure; and

FIG. 8 is a schematic diagram showing pulsing of a bag, utilizing principles of this disclosure.

### DETAILED DESCRIPTION

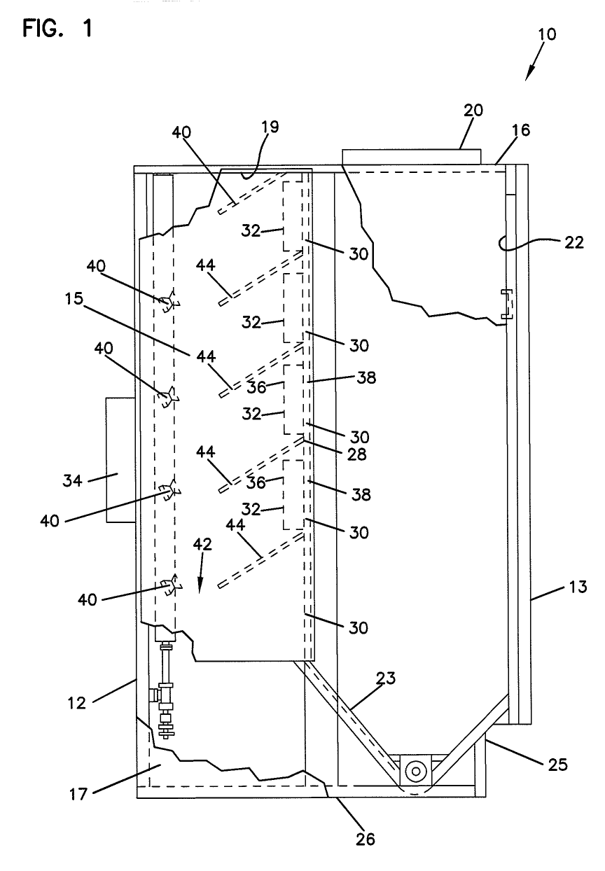

A dust collector or air cleaner system is shown at 10 in FIG. 1. The system depicted includes a collector housing having side wall panel 17 broken away to illustrate the arrangement of various portions of the assembly. An upper wall panel 16 has an inner wall surface 19. In this embodiment, an air inlet 20 is positioned in the upper wall panel 16 so that the particulate-laid in air or other fluid is introduced into an unfiltered (dirty) fluid chamber 22. The unfiltered chamber 22 is defined by an access door 13, the upper wall panel 16, opposing side wall panels 17, a tubesheet 28, and a bottom surface 23 partially defining a collection area or hopper 25. The bottom base panel or frame 26 is secured to the side wall panels 17 in a suitable manner.

The tubesheet 28 is mounted in the interior of the housing 12. The tubesheet 28 includes a plurality of openings 30. Within each opening 30 is mounted an individual filter element, which in the illustrated embodiment, is a panel-style filter element 32. By the term “panel-style filter element,” it is meant an element with filter media in which, in general, fluid to be filtered flows through the filter element in a straight-flow through manner. For example, a panel-style filter element can be pleated media, depth media, fluted media, Z-media, or any V-packs. By “Z-media,” it is meant media having first and second opposite flow faces with a plurality of flutes, each of the flutes having a upstream portion adjacent to the first flow face and a downstream portion adjacent to the second flow face, selected ones of the flutes being open at the upstream portion and closed at the downstream portion, while selected ones of the flutes are closed at the upstream portion and open at the downstream portion. The flutes can be straight, tapered, or darted. Examples of filter elements with Z-media are found in, for example, U.S. Pat. No. 5,820,646; U.S. Patent Publication 2003/0121845; and U.S. Pat. No. 6,350,291, each of these patent documents being incorporated by reference herein.

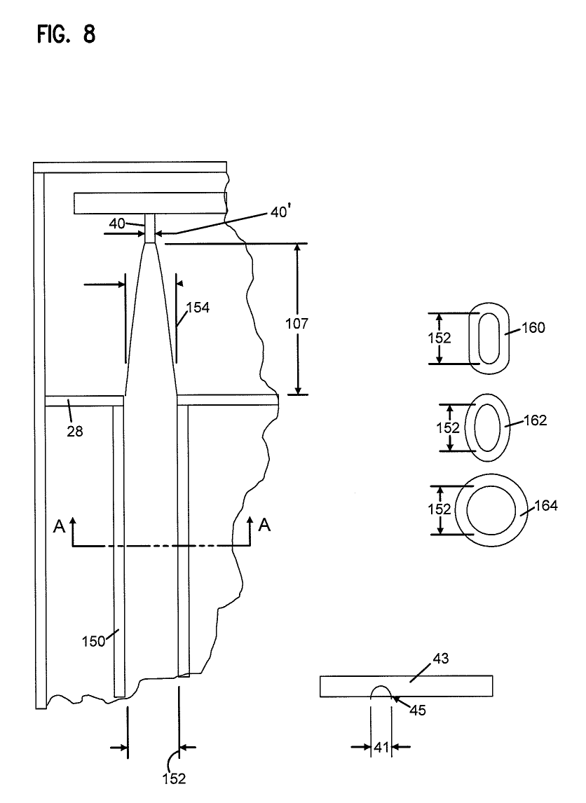

In operation, fluid, such as air, to be filtered flows into the system 10 through the inlet 20. From there, it flows through the filter elements 32. The filter elements 32 remove particulate material from the fluid. The filtered fluid then flows into clean air or filtered flow chamber 15. From there, the clean air flows through an outlet 34. Periodically, the filtered elements 32 will be cleaned by pulsing a fluid jet, such as a jet of air from a downstream side 36 of the filter element 32 to an upstream side 38 of the filter element 32. Specifically, a jet of pressurized gas will be directed through individual blowpipes 43 (FIG. 8), each blowpipe 43 having a hole 45 with a diameter 41 (FIG. 8), and each blowpipe 43 having a nozzle 40. A respective nozzle 40 is oriented for each of the respective filter elements 32. This will direct the jet through each filter element 32, from the downstream side 36 to the upstream side 38. This helps to knock debris and particulate from the upstream side 38 of the filter element 32, directing it off the filter element 32 and into a hopper.

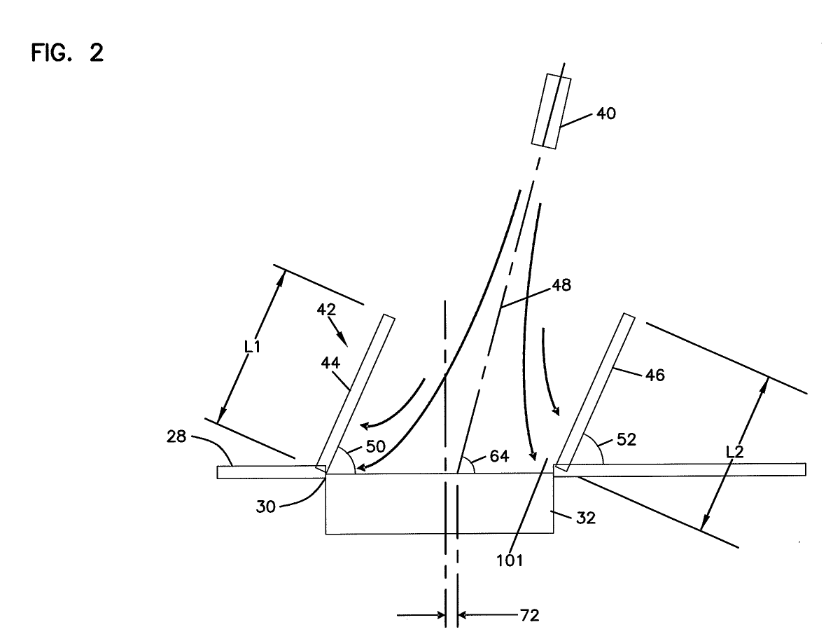

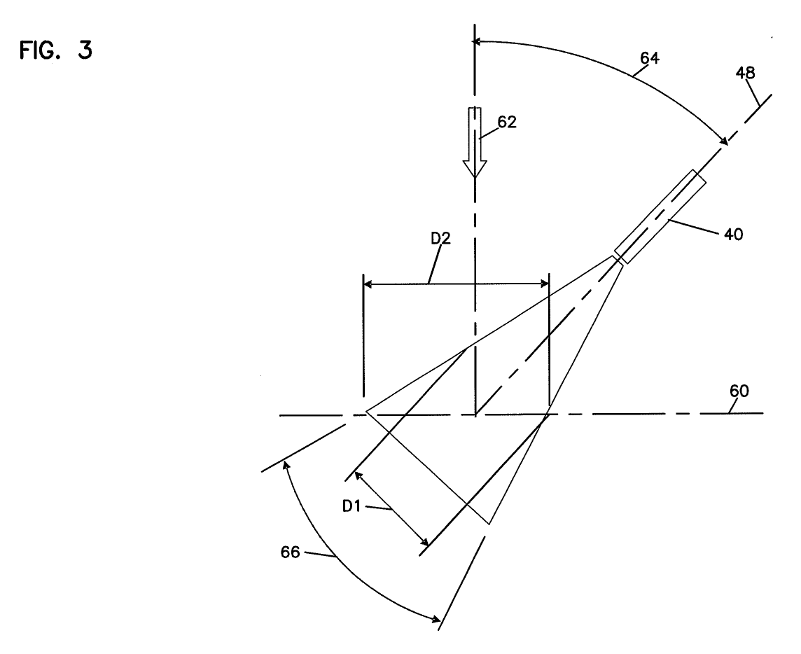

A schematic illustration of a portion of the system 10 is illustrated in FIG. 2. In FIG. 2, the nozzle 40 can be seen oriented with respect to one of the filter elements 32 in the opening 30 of the tubesheet 28. The nozzle 40 is oriented relative to the filter element 32 in a plane 60 (FIG. 3) that contains the respective opening 30 in the tubesheet 28 for the respective filter element 32, such that a pulse that comes from the nozzle 40 is at an angle that is not normal to a plane of the opening 30 and is not in line with a general direction of filtration flow through the filter element 32. By the term “not normal,” it is meant non-orthogonal, such as at an acute or obtuse angle relative to the plane 60 that contains the opening 30 for the respective filter element 32. By “not in line with a general direction of filtration flow,” it is meant for a straight-through flow filter, the pulse flow is at a direction that is not parallel to the flow of direction through the filter element 32. By directing the fluid pulse at the filter element 32 at an angle 64, the exhaust jet, which expands at a predictable angle, creates a diameter D2 (FIG. 3) larger in one direction than a diameter D1 that is typically used in the prior art.

Also shown in FIG. 2 is an accumulator arrangement 42. The accumulator arrangement 42 captures the flow of the pulse from the nozzle 40. In this embodiment, the accumulator arrangement 42 includes at least one plate 44 oriented on the clean air side 15 of the tubesheet 28 and adjacent to the opening 30 of the tubesheet 28. In some arrangements, the accumulator arrangement 42 further includes a second plate 46 oriented at an opposite end of the opening 30 at the tubesheet 28 from the first plate 44.

FIG. 2 illustrates a center line of the direction of the pulse at 48. The first plate is mounted at a first angle 50 relative to the tubesheet 28. The first angle is within about 5 degrees of center line 48. Similarly, the second plate 46 is mounted at angle 52 which is about 5 degrees relative to the center line 48.

In FIG. 3, arrow 62 represents prior art pulse directions. In the prior art, the standard pulse direction is directed perpendicular or normal to the plane 60 that contains the tubesheet 28. Angle 64 shows the angle that is offset to the vertical direction, or the direction from the standard prior art direction shown by arrow 62. A typical pulse expansion is shown at angle 66 from the nozzle 40. The exhaust jet from the nozzle 40 creates a diameter D2, covering a larger surface area in the opening 30 of the tubesheet 28, versus diameter D1 that comes from the exhaust shown at arrow 62 in the prior art arrangement.

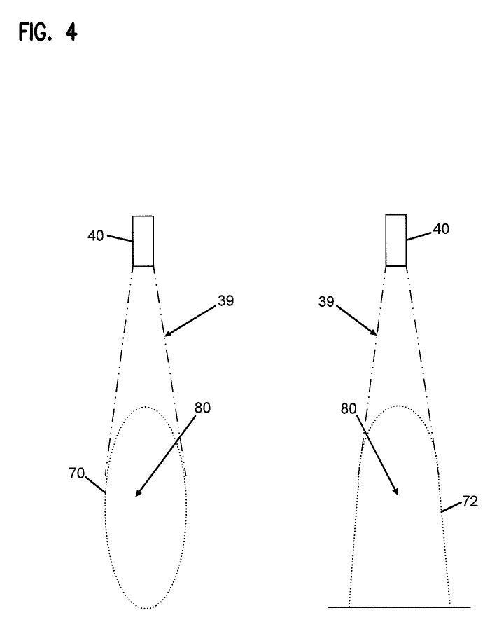

In FIG. 4, the general cross-sectional shape of the pulse is shown, when the pulse is directed through the nozzle 40 in a direction toward the filter element 32 and not normal to the plane 60 of the tubesheet 28. The general pulse expansion flow lines are depicted at 39. A pulse shape 70, having a general oval or elliptical shape is shown when the nozzle 40 is directed at a filter element 32 that does not have accumulator walls 44, 46. When accumulator walls 44, 46 are utilized, the pulse will have a general cross-sectional shape as shown at 72. Pulse shape 72 has the shape of approximately a truncated parabola. The pulse shapes 70, 72 have an effective pulse region 80 when pulsed at an angle not normal to the plane of the tubesheet 28.

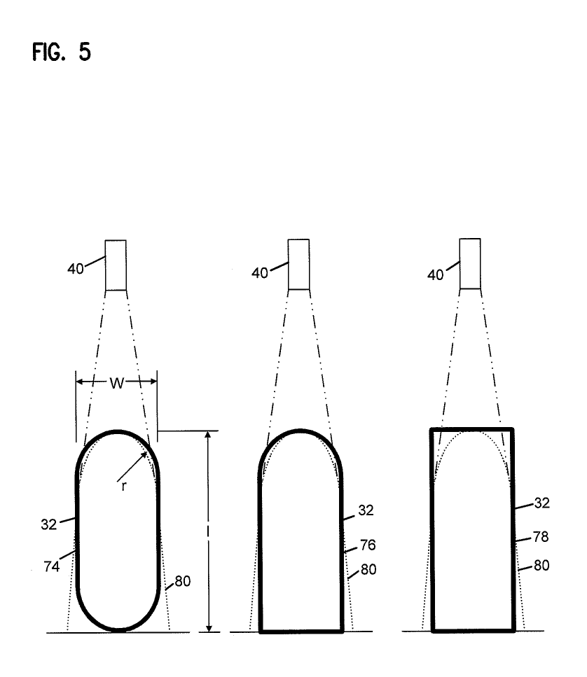

In FIG. 5, various shaped filter elements 32 are shown schematically being pulsed. An obround, or oval element is shown at 74. In the specific embodiment illustrated, the element 74 is racetrack shaped, in that it has a pair of parallel sides joined by rounded ends. A rectangular element having a rounded end is shown at 76. A rectangular element 78 is also shown. In FIG. 5, note how the shape of the pulse 80 matches the shapes of the filters 74, 76, 78. This maximizes the filter area in the region of the effective pulse 80. In each case, the element has a width W and a length L.

It has been found that if the filter element shape is selected based on blowpipe geometry, a preferred filter shape may be selected in order to maximize the filtration area in the region of the effective pulse. For example, the inventor has discovered that by measuring the inside diameter 41 of the blowpipe 43 and then selecting the filter element to have media with a width W that is 7.125±0.75 inches times the inside diameter 41 of the blowpipe 43, this is the most effective filter width. Furthermore, once the width is selected, the length L can be selected. The inventor has discovered that if the length is about 2.2-3.3 times the width W of the filter media, then the size of the filter element 32 will be maximized in the region of the effective pulse 80.

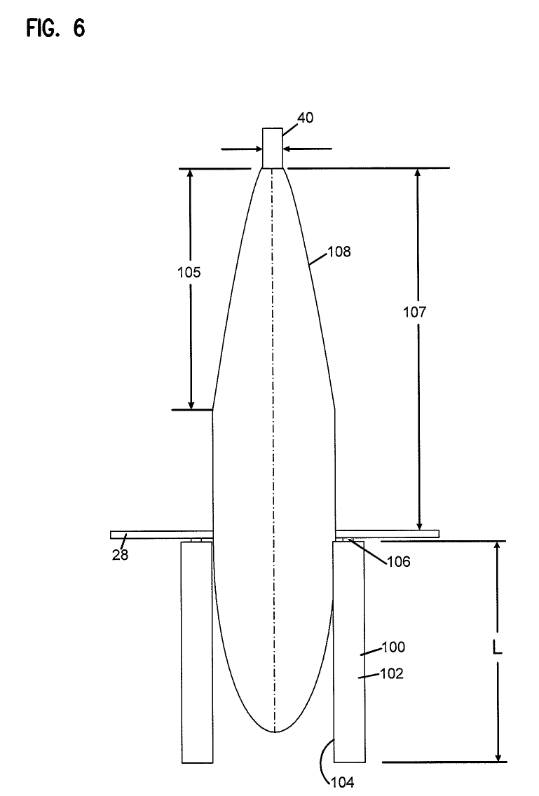

FIG. 6 illustrates this method utilized on a tubular filter element, tubular bag, or pleated bag. In FIG. 6, the filter element is shown at 100, including media 102 and an open filter interior 104, which, in this embodiment, corresponds to an inside diameter of the filter element 100. The element 100 is operably installed against a tubesheet 28, and a gasket 106 provides a seal between the element 100 and the tubesheet 28. The nozzle 40 emits pulse 108, such that it goes through the opening in the tubesheet 28 and to the open filter interior 104. The open filter interior 104 is also the downstream side of the filter element 100. The minimum distance to the effective pulse maximum region is shown at 105, while the maximum distance to the effective pulse maximum region is shown at 107.

The inventor has discovered that if the width, defined as the inside diameter of the filter element 100 is about 7.125±0.75 inches times the inside diameter of the nozzle 40, and the length L is selected to be 2.2-3.3 times the width of the filter element 100, then the shape of the filter element 100 will match the effective pulse width 108.

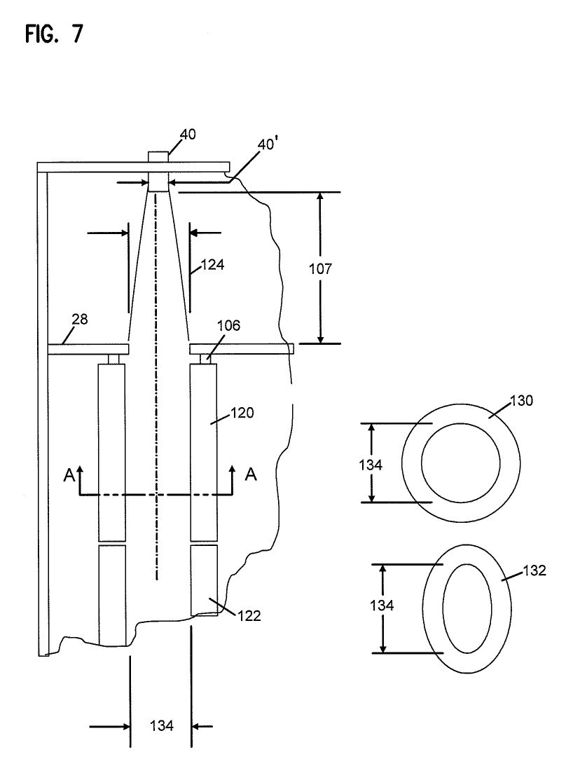

FIG. 7 shows a schematic diagram of a tubular filter element system, including a pair of elements 120, 122 stacked axially. A gasket 106 seals the element 120 against the tubesheet 28. The effective pulse diameter is shown at 124. In this embodiment, the filter elements 120, 122 are shown as being either cylindrical 130 or oval 132. The inner diameter 134 of the filter elements 120, 122 are shown, and for the oval element 132, the inner diameter 134 is the long axis of the cross-section of the oval 132. In preferred arrangements, the oval cross-section has a short axis to long axis ratio of 0.8. Again, the width 134 should be about 7.125±0.75 inches times the inside diameter 40′ of the nozzle 40, and the overall length of the stacked elements 120, 124 should be 2.2-3.3 times the width 134 to match the shape of the filter elements 120, 124 with the effective pulse width 124.

FIG. 8 shows a pulse arrangement 40 a bag or pleated bag system. A bag or pleated bag 150 has an inside diameter 152. The nozzle 40 exhausts or pulses a pulse having an effective pulse diameter 154. The bag element 150 is installed in the tubesheet 28. The bag 150 can have different cross-sectional shapes including racetrack 160, oval 162, and circular or round 164. The width is shown at the inside diameter 152. The width 152 is selected based on diameter 41 of the nozzle 40. The width 152 is 7.125±0.75 inches times the inside diameter 41 of the nozzle 40. The length of the filter 150 is selected based on the width of the filter. Specifically, the length is 2.2-3.3 times the width of the filter.

Based on the above, it should be appreciated that a method of providing a filter element for a dust collector can be implemented. The dust collector includes at least one circular blowpipe and pulse arrangement. The pulse arrangement emits pulses of gas through the blowpipe in a direction toward a downstream side of the filter element. The method includes measuring an inside diameter of the blowpipe and then selecting a filter element. The filter element will be sized to have a width that is 7.125±0.75 inches times the inside diameter of the blowpipe and a length that is 2.2-3.3 times the width of the filter element.

In general, a method of providing a filter element for a dust collector in which the dust collector includes at least one circular blowpipe and pulse arrangement is provided. The pulse arrangement emits pulses of gas through the blowpipe in a direction toward a downstream side of the filter element. The method includes measuring an inside diameter of an opening in the blowpipe; and selecting a filter element having: a width that is 7.125±0.75 inches times the inside diameter of the blowpipe; and a length that is 2.2-3.3 times the width of the filter element.

The filter element selected can be a panel filter.

The filter element selected can be an oval panel filter; a racetrack shaped panel filter; and a rectangular panel filter.

The filter element can include pleated media.

The filter element can includes Z-media.

The filter element selected can be tubular.

The filter element selected can have a round cross-section.

The filter element selected can have an oval cross-section and has a short axis to long axis ratio of 0.8.

The filter element selected can be a bag filter.

The above represents a description of principles and example embodiments. Many embodiments can be made from these principles.

I claim:

1. A method of providing a filter element for a dust collector; the dust collector including at least one circular blowpipe and pulse arrangement; the pulse arrangement emitting pulses of gas through the blowpipe in a direction toward a downstream side of the filter element; the method comprising:
(a) measuring an inside diameter of an opening in the blowpipe; and
(b) selecting a filter element having:
(i) a width that is 7.125±0.75 inches times the inside diameter of the blowpipe; and
(ii) a length that is 2.2-3.3 times the width of the filter element.

2. A method according to claim 1 wherein the filter element selected is a panel filter.

3. A method according to claim 2 wherein the filter element includes pleated media.

4. A method according to claim 3 wherein the filter element selected is one of: an oval panel filter; a racetrack shaped panel filter; and a rectangular panel filter.

5. A method according to claim 2 wherein the filter element selected is one of: an oval panel filter; a racetrack shaped panel filter; and a rectangular panel filter.

6. A method according to claim 5 wherein the filter element includes Z-media.

7. A method according to claim 2 wherein the filter element includes Z-media.

8. A method according to claim 1 wherein the filter element selected is tubular.

9. A method according to claim 8 wherein the filter element selected has a round cross-section.

10. A method according to claim 8 wherein the filter element selected has an oval cross-section and has a short axis to long axis ratio of 0.8.

11. A method according to claim 8 wherein the filter element selected has pleated media.

12. A method according to claim 1 wherein the filter element selected is a bag filter.
